(19) United States
(12) Patent Application Publication
(10) Pub. No.: US 2024/0217379 A1
(43) Pub. Date: Jul. 4, 2024

(54) DUAL-STANDARD AC SMART CHARGING PILE

(71) Applicants: MICRO-STAR INT’L CO.,LTD., New Taipei City (TW); MSI COMPUTER (SHENZHEN) CO.,LTD., Shenzhen City (CN)

(72) Inventors: Chuan Yi LIN, New Taipei City (TW); Hong Hen LIN, New Taipei City (TW); Chi Yang LIN, New Taipei City (TW); Chien-Chi HSU, New Taipei City (TW)

(73) Assignees: MICRO-STAR INT’L CO.,LTD., New Taipei City (TW); MSI COMPUTER (SHENZHEN) CO.,LTD., Shenzhen City (CN)

(21) Appl. No.: 18/223,471

(22) Filed: Jul. 18, 2023

Related U.S. Application Data
(60) Provisional application No. 63/436,065, filed on Dec. 29, 2022.

(51) Int. Cl. B60L 53/67; B60L 53/30; B60L 53/34; B60L 53/63

(52) U.S. Cl. CPC B60L 53/67; B60L 53/305; B60L 53/34; B60L 53/63

(57) ABSTRACT

A dual-standard AC smart charging pile includes a first charging gun, a first power supply circuit, a second charging gun, a second power supply circuit and a signal processing circuit. Each of the two charging guns comprises a charging port conforming to different specifications. Each of the two power supply circuits is electrically connected to the corresponding charging gun, and is respectively configured to provide power to the corresponding charging gun based on different specifications. The signal processing circuit is electrically connected to the first charging gun, the second charging gun, the first power supply circuit and the second power supply circuit, and is configured to control one or both of the first power supply circuit and the second power supply circuit according to one or both of a first trigger time point of the first charging gun and a second trigger time point of the second charging gun.

### CROSS-REFERENCE TO RELATED APPLICATIONS

This non-provisional application claims priority under 35 U.S.C. § 119(a) on Patent Application No(s). 63/436,065 filed in US on Dec., 29th, 2022, the entire contents of which are hereby incorporated by reference.

### BACKGROUND

### 1. Technical Field

This disclosure relates to a charging pile, especially to a dual-standard AC smart charging pile.

### 2. Related Art

Since there is no single standard of the connectors of electric vehicle charging piles, and the charging pile designs so far are all single-gun designs, which is reasonable and appropriate under the condition that the consumers already determine their choice of vehicle. However, if the charging service is built in commercial or public places, it is necessary to consider the percentage and allocation of building charging piles with various specifications. And this plan may greatly affect the difficulty of service setting and the construction efficiency of charging parking spaces.

Along with the development of electric vehicle charging piles, there are various types of connectors in the design of the communication protocol of the charging system. Therefore, for some regions or countries that do not restrict a single standard or have access to different specifications and standards, the construction of charging piles at the destination with charging services may be challenging.

### SUMMARY

Accordingly, this disclosure provides a dual-standard AC smart charging pile.

According to one or more embodiment of this disclosure, a dual-standard AC smart charging pile comprises a first charging gun, a first power supply circuit, a second charging gun, a second power supply circuit and a signal processing circuit. The first charging gun comprises a charging port conforming to a first specification. The first power supply circuit is electrically connected to the first charging gun and configured to provide power to the first charging gun based on the first specification. The second charging gun comprises a charging port conforming to a second specification different from the first specification. The second power supply circuit is electrically connected to the second charging gun and configured to provide power to the second charging gun based on the second specification. The signal processing circuit is electrically connected to the first power supply circuit and the second power supply circuit, and is configured to control one or both of the first power supply circuit and the second power supply circuit according to one or both of a first trigger time point of the first charging gun and a second trigger time point of the second charging gun.

In view of the above description, the dual-standard AC smart charging pile of the present disclosure can be equipped with charging guns with different charging specifications, and can be used by different electric vehicles at the same time, and can implement smart current distribution according to the trigger time point of charging. In this way, by adopting a fixed current scheme, or depending on the power usage status in the field, or according to the management platform or the power supply setting results of individual piles, the power output can be regulated in a smart way. And it can be used for two parking spaces to share one charging pile, serving two vehicles of different specifications at the same time, and reducing the overall construction cost.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of a dual-standard AC smart charging pile according to an embodiment of the present disclosure.

FIG. 2 is an operation flow chart of a dual-standard AC smart charging pile according to an embodiment of the present disclosure.

FIG. 3 is a detail operation flow chart of a dual-standard AC smart charging pile according to the embodiment shown in FIG. 2.

FIG. 4 is another detail operation flow chart of a dual-standard AC smart charging pile according to the embodiment shown in FIG. 2.

FIG. 5 is a functional block diagram of a dual-standard AC smart charging pile according to another embodiment of the present disclosure.

FIG. 6 is a functional block diagram of a dual-standard AC smart charging pile according to still another embodiment of the present disclosure.

FIG. 7 is an operation flow chart of a dual-standard AC smart charging pile according to still another embodiment of the present disclosure.

FIG. 8 is a detail operation flow chart of a dual-standard AC smart charging pile according to the embodiment shown in FIG. 7.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

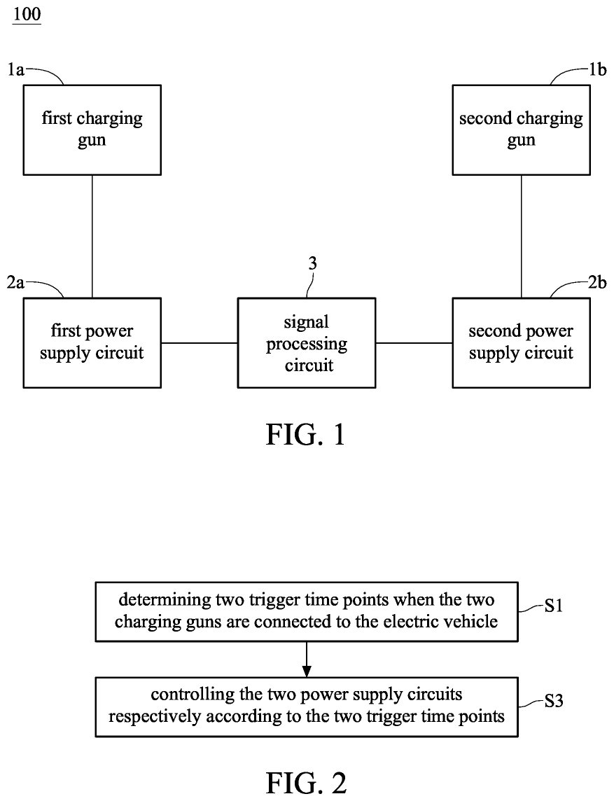

Please refer to FIG. 1 which is a functional block diagram of a dual-standard AC smart charging pile according to an embodiment of the present disclosure. As shown in FIG. 1, a dual-standard AC smart charging pile 100 comprises a first charging gun 1a, a first power supply circuit 2a, a second charging gun 1b, a second power supply circuit 2b and a signal processing circuit 3. The first charging gun 1a comprises a charging port conforming to a first specification. The first power supply circuit 2a is electrically connected to the first charging gun 1a and configured to provide power to the first charging gun 1a based on the first specification. The second charging gun 1b comprises a charging port conforming to a second specification different from the first specification. The second power supply circuit 2b is electrically connected to the second charging gun 1b and configured to provide power to the second charging gun 1b based on the second specification. The signal processing circuit 3 is electrically connected to the first power supply circuit 2a and the second power supply circuit 2b, and is configured to control one or both of the first power supply circuit 2a and the second power supply circuit 2b according to one or both of a first trigger time point of the first charging gun 1a and a second trigger time point of the second charging gun 1b.

In the present embodiment, the first specification of the first charging gun 1a may be an AC charging specification according to one of SAE J1772 (Type 1), IEC 62196 (Type 2), GBT 20234.2-2015 and the North American Charging Standard (NACS), and the second specification of the second charging gun 2a may be an AC charging specification according to another one of SAE J1772 (Type 1), IEC 62196 (Type 2), GBT 20234.2-2015 and the North American Charging Standard (NACS). In other embodiment, the first charging gun 1a and the second charging gun 2a can also be based on other AC charging specifications to meet the charging requirement in different regions. The first power supply circuit 2a and the second power supply circuit 2b may each include a charging communication circuit, such as a circuit supporting a control pilot, for being controlled by the signal processing circuit 3 to adjust the power supply of the corresponding charging gun. In one embodiment, the first power supply circuit 2a and the second power supply circuit 2b can be connected to a common power supply system. The signal processing circuit 3 may include computing component such as a microcontroller or a programmable logic controller etc. to control the two power supply circuits. Specifically, the signal processing circuit 3 can control the power of the electric power output by the two charging guns through the first power supply circuit 2a and the second power supply circuit 2b respectively.

Please refer to FIG. 2 along with FIG. 1, FIG. 2 is an operation flow chart of a dual-standard AC smart charging pile according to an embodiment of the present disclosure. As shown in FIG. 1 and FIG. 2, the signal processing circuit 3 of the present embodiment can perform: step S1: determining two trigger time points when the two charging guns (the first charging gun 1a and the second charging gun 1b) are connected to the electric vehicles; and step S3: controlling the two power supply circuits (the first power supply circuit 2a and the second power supply circuit 2b) respectively according to the two trigger time points. Specifically, when the charging port of the first charging gun 1a is connected to a first electric vehicle, the signal processing circuit 3 can receive a trigger signal from the first charging gun 1a through a communication circuit, and generate a first trigger time point according to the trigger signal, and control the first power supply circuit 2a to provide power to the first charging gun 1a to perform the charging operation. And the description about triggering and charging of the second charging gun 2a is the same as that of the first charging gun 1a, which is not repeated herein. When the charging ports of the first charging gun 1a and the second charging gun 1b are connected to their respective electric vehicles at the same time, the signal processing circuit 3 can simultaneously control the first power supply circuit 2a and the second power supply circuit 2b to provide power to the corresponding charging gun, and the sum of charging power or current on both sides can be adjusted to not exceed a rated maximum charging power. Further, when the charging port of the first charging gun 1a is connected to a first electric vehicle, and then the charging port of the second charging gun 1b is connected to a second electric vehicle, the signal processing circuit 3 can first distribute the rated maximum charging power to the first power supply circuit 2a according to the first trigger time point, and then distribute the rated maximum charging power equally to the first power supply circuit 2a and the second power supply circuit 2b according to the second trigger time point.

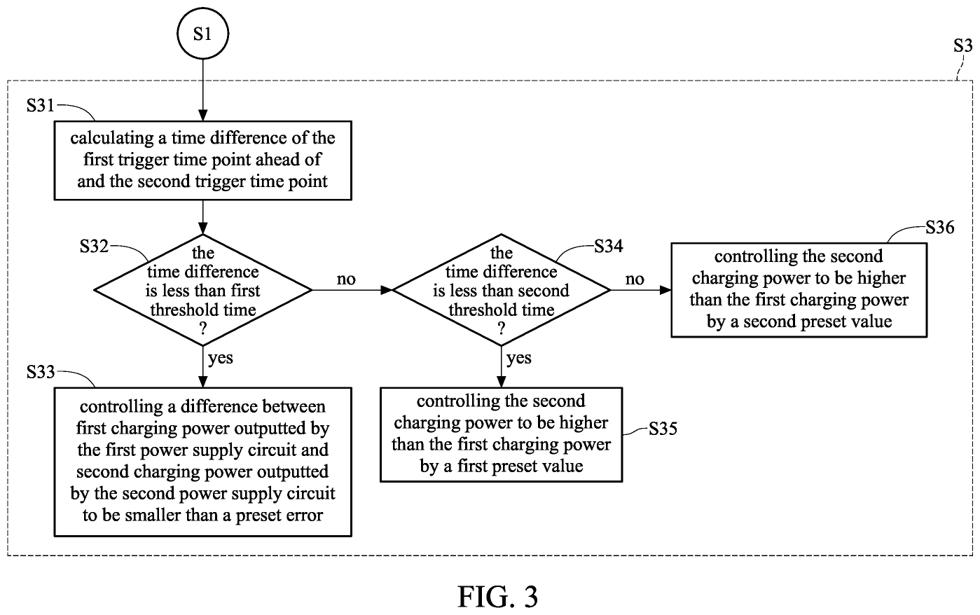

Please refer to FIG. 3 along with FIG. 2, FIG. 3 is a detail operation flow chart of a dual-standard AC smart charging pile according to the embodiment shown in FIG. 2. As shown in FIG. 3, step S3 performed by the signal processing circuit after step S1 may include: step S31: calculating a time difference of the first trigger time point ahead of and the second trigger time point; step S32: determining whether the time difference is less than first threshold time; when the determination result of step S32 is yes, performing step S33: controlling a difference between first charging power outputted by the first power supply circuit and second charging power outputted by the second power supply circuit to be smaller than a preset error; when the determination result of step S32 is no, performing step S34: determining whether the time difference is less than a second threshold time; when the determination result of step S34 is yes, performing step S35: controlling the second charging power to be higher than the first charging power by a first preset value; when the determination result of step S34 is no, performing step S36: controlling the second charging power to be higher than the first charging power by a second preset value. It should be noted that the above steps are taken as an example where the first trigger time point precedes the second trigger time point, but this embodiment can also be applied to the situation where the second trigger time point precedes the first trigger time point. In that case, the corresponding steps S35 and S36 are modified into “controlling the first charging power to be higher than the second charging power . . . ”, and repeated descriptions are omitted herein. In addition, the order of step S32 and step S34 can be swapped or performed simultaneously, which is not limited in the present disclosure. Specifically, for the solution of controlling the charging power in steps S33, S35 and S36, please refer to Table 1 shown below as an example.

TABLE 1

| Charging time difference | | |
|---|---|---|
| (taking the first trigger time | | |
| point preceding the second | First charging gun | Second charging gun |
| trigger time point as example) | (of first specification) | (of second specification) |
| One charging gun at a time | Output current = 60 A | N/A |
| (the first charging gun) | | |
| One charging gun at a time | Output current = 0 A | N/A |
| (the first charging gun) and | | |
| the electric vehicle is | | |
| already fully charged | | |
| Charging time difference is | Output current = 30 A, but if the first | Output current = 30 A, but if the first |
| less than 2 hours | electric vehicle is already fully | electric vehicle is already fully |
| | charged, then output current = 0 A. | charged, then output current = 60 A. |
| Charging time difference is | Output current = 25 A, but if the first | Output current = 35 A, but if the first |
| between 2 hours and 4 hours | electric vehicle is already fully | electric vehicle is already fully |
| | charged, then output current = 0 A. | charged, then output current = 60 A. |
| Charging time difference | Output current = 15 A, but if the first | Output current = 45 A, but if the first |
| exceeds 4 hours | electric vehicle is already fully | electric vehicle is already fully |
| | charged, then output current = 0 A. | charged, then output current = 60 A. |

As shown in Table 1, the dual-standard AC smart charging pile in the present embodiment can be used to provide different charging schemes according to the time difference between the two charging time points of the two charging guns. In the beginning, when a charging gun is connected to an electric vehicle, the signal processing circuit can determine whether there is only one charging gun used for charging. If there is only one charging gun used for charging, the initial current allocated by the charging pile to the charging gun can be properly adjusted to the upper limit current (e.g. 60 amperes) according to the available current standard of the charging gun. That is, the charging pile can adjust the charging current according to the current tolerance range of the charging gun until the charging operation is completed.

Further, please refer to Table 1 along with FIG. 3. When the two charging guns are both used for charging the electric vehicles, the power and current distribution of the two charging guns must be planned. In steps S31 to S33, when the time difference between the first trigger time point and the second trigger time point is less than the first threshold time, the signal processing circuit can control a difference between the first charging power output by the first charging gun and the second charging power output by the first charging gun to be smaller than a preset error, by using the first power supply circuit and the second power supply circuit, especially by using the charging communication circuits of the power supply circuits. Specifically, if the signal processing circuit determines that the time difference between the two trigger times is less than the first threshold time (for example, less than two hours), the charging power of the two charging guns are controlled in a balanced output way, so that the charging power of the two charging guns are basically the same (for example, the output current of the first and second charging guns are 30 amperes). In steps S34 and S35, when the time difference is not less than the first threshold time and less than a second threshold time, the signal processing circuit can control the second charging power to be higher than the first charging power by a first preset value. Specifically, if the signal processing circuit determines that the time difference between the two trigger time points is not less than the first threshold time and less than the second threshold time (for example, between two hours and four hours), then the second charging power is controlled to be higher than the first charging power by a first preset value (for example, the first preset value can be set to 10 amperes, then the output current of the first charging gun is 25 amperes, and the output current of the second charging gun current is 35 amperes). In step S36, when the time difference is not less than the second threshold time, the signal processing circuit can control the second charging power to be higher than the first charging power by a second preset value. Specifically, if the signal processing circuit determines that the time difference between the two trigger time points is not less than the second threshold time (for example, not less than four hours), the second charging power is controlled to be higher than the first charging power by a second preset value (for example, the second preset value can be set to 30 amperes, then the output current of the first charging gun is 15 amperes, and the output current of the second charging gun current is 45 amperes). In the case where the above two charging guns are both in use, the current adjustment performed by the charging pile would not cause the output current of the two charging guns to exceed their respective specified currents. It should be noted that the various values listed in Table 1, such as current values or various time parameters, are just examples, and in other implementations, an appropriate upper limit current (for example, 80 amperes) may be set according to actual conditions, and then the above-mentioned first preset value and second preset value may be adjusted proportionally.

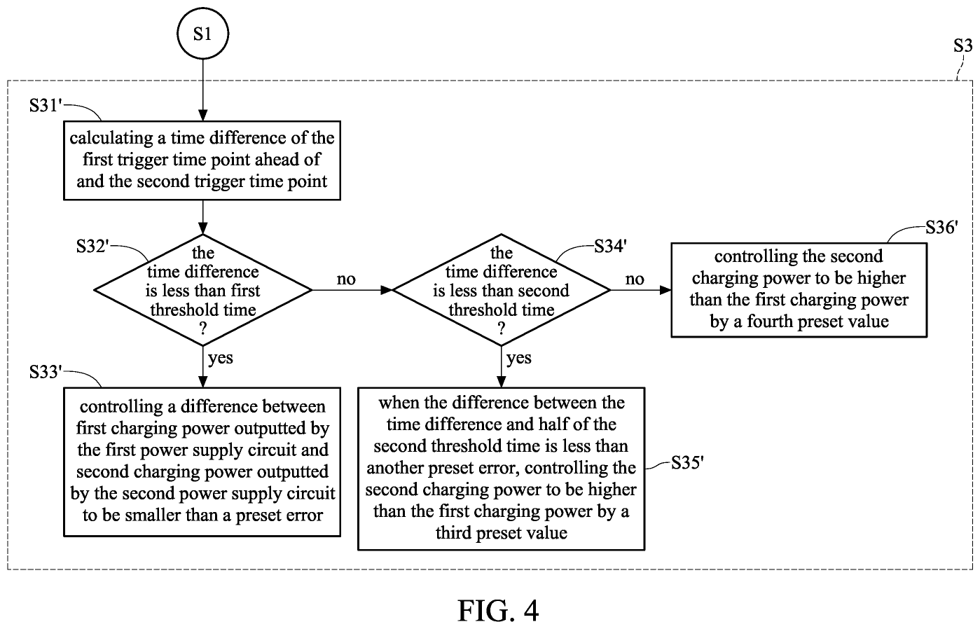

Please refer to FIG. 4 along with FIG. 2, FIG. 4 is another detail operation flow chart of a dual-standard AC smart charging pile according to the embodiment shown in FIG. 2. As shown in FIG. 4, step S3 performed by the signal processing circuit after step S1 may include: step S31′: calculating a time difference of the first trigger time point ahead of the second trigger time point; step S32′: determining whether the time difference is less than first threshold time; when the determination result of step S32′ is yes, performing step S33′: controlling a difference between first charging power outputted by the first power supply circuit and second charging power outputted by the second power supply circuit to be smaller than a preset error; when the determination result of step S32′ is no, performing step S34′: determining whether the time difference is less than second threshold time; when the determination result of step S34′ is yes, performing step S35′: when the difference between the time difference and half of the second threshold time is less than another preset error, controlling the second charging power to be higher than the first charging power by a third preset value; when the determination result of step S34′ is no, performing step S36′: controlling the second charging power to be higher than the first charging power by a fourth preset value. It should be noted that the above steps are taken as an example where the first trigger time point precedes the second trigger time point, but this embodiment can also be applied to the situation where the second trigger time point precedes the first trigger time point. In that case, the corresponding steps S35′ and S36′ are modified into “controlling the first charging power to be higher than the second charging power . . . “, and repeated descriptions are omitted herein. In addition, the order of step S32” and step S34′ can be swapped or performed simultaneously, which is not limited in the present disclosure.

In steps S31′ to S33′, when the time difference between the first trigger time point and the second trigger time point is less than the first threshold time, the signal processing circuit can control a difference between the first charging power output by the first charging gun and the second charging power output by the first charging gun to be smaller than a preset error, by using the first power supply circuit and the second power supply circuit, especially by using the charging communication circuit of the power supply circuit. Specifically, if the signal processing circuit determines that the time difference between the two trigger times is less than the first threshold time (for example, less than one hour), the charging power of the two charging guns are controlled in a balanced output way, so that the charging power of the two charging guns are basically the same (for example, the output current the first and second charging guns are 30 amperes). In steps S34′ and S35′, when the difference between the time difference and half of the second threshold time is less than another preset error, the signal processing circuit can control the second charging power to be higher than the first charging power by a third preset value. Specifically, if the signal processing circuit determines that a difference between the time difference of the two trigger time points and half of the second threshold time (for example, 4 hours) is less than another preset error, then the second charging power is controlled to be higher than the first charging power by a third preset value (for example, the output current of the first charging gun is 25 amperes, and the output current of the second charging gun current is 35 amperes). In step S36′, when the time difference is not less than the second threshold time, the signal processing circuit can control the second charging power to be higher than the first charging power by a fourth preset value. Specifically, if the signal processing circuit determines that the time difference between the two trigger time points is not less than the second threshold time, the second charging power is controlled to be higher than the first charging power by a fourth preset value (for example, the output current of the first charging gun is 15 amperes, and the output current of the second charging gun current is 45 amperes).

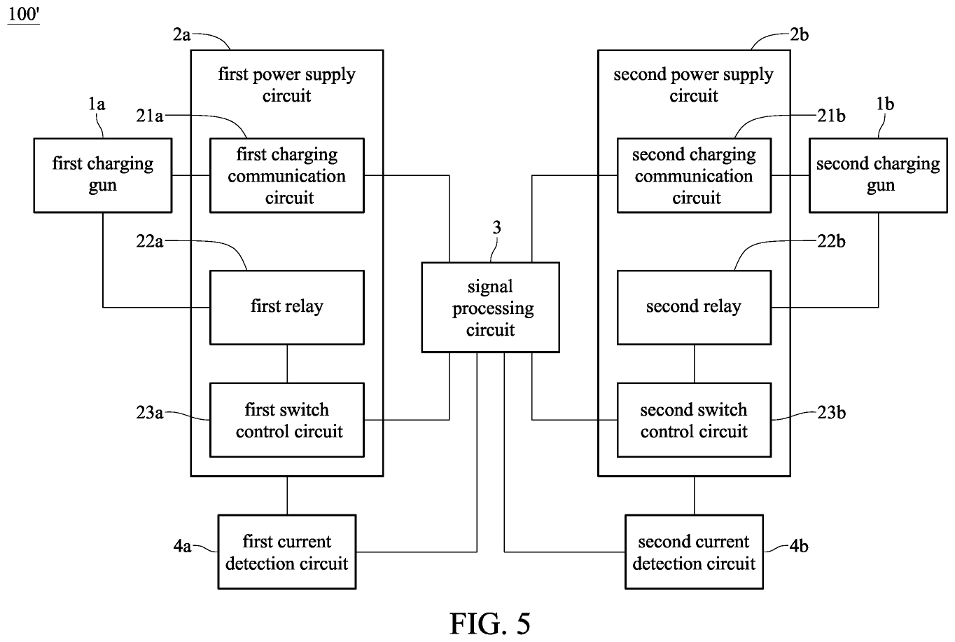

Please refer to FIG. 5 which is a functional block diagram of a dual-standard AC smart charging pile according to another embodiment of the present disclosure. As shown in FIG. 5, the dual-standard AC smart charging pile 100′ also includes the first charging gun 1a, the first power supply circuit 2a, the second charging gun 1b, the second power supply circuit 2b and the signal processing circuit 3 as shown in FIG. 1, wherein the first power supply circuit 2a includes a first charging communication circuit 21a, and the second power supply circuit 2b includes a second charging communication circuit 21b. The first charging communication circuit 21a is electrically connected to the first charging gun 1a and the signal processing circuit 3. The second charging communication circuit 21b is electrically connected to the second charging gun 1b and the signal processing circuit 3. In the present embodiment, the signal processing circuit 3 is configured to perform: when the first charging gun 1a is connected to a first electric vehicle, obtaining a first communication signal of the first electric vehicle through the first charging communication circuit 21a to obtain a first trigger time point, and then controlling the first charging gun 1a to output power through the first power supply circuit 2a according to the first specification and the first communication signal; and when the second charging gun 1b is connected to a second electric vehicle, obtaining a second communication signal of the second electric vehicle through the second charging communication circuit 21b to obtain a second trigger time point, and then controlling the second charging gun 1b to output power through the second power supply circuit 2b according to the second specification and the second communication signal.

In the present embodiment, the first charging communication circuit 21a and the second charging communication circuit 21b may each have a wired communication unit, which is signally connected to the signal processing circuit 3 and the corresponding charging gun. For example, the first charging communication circuit 21a and the second charging communication circuit 21b may be circuits supporting control pilot. The signal processing circuit 3 can respectively obtain the communication signals of the electric vehicles connected to the first charging gun 1a and the second charging gun 2a through the first charging communication circuit 21a and the second charging communication circuit 21b, and control the first power supply circuit 2a and the second power supply circuit 2b to charge accordingly. In the present embodiment, the first power supply circuit 2a may further optionally include a first relay 22a and a first switch control circuit 23a, and the second power supply circuit 2b may further optionally include a second relay 22b and a second switch control circuit 23b. The first/second relays 22a/22b are electrically connected to the first/second charging guns 1a/1b respectively, for providing power to the first/second charging guns 1a/1b. The first/second switch control circuits 23a/23b are electrically connected to the first/second relays 22a/22b respectively and connected to the signal processing circuit 3, and are controlled by the signal processing circuit 3 to respectively adjust the first/second relays 22a/22b to be in a disabled state or an enabled state, that is, to adjust “on” or “off” of the first/second charging gun 1a/1b.

As shown in FIG. 5, the dual-standard AC smart charging pile 100′ of the present embodiment further includes a first current detection circuit 4a and a second current detection circuit 4b. The first current detection circuit 4a is electrically connected to the first power supply circuit 2a and the signal processing circuit 3. The second current detection circuit 4b is electrically connected to the second power supply circuit 2b and the signal processing circuit 3. In one implementation, the first current detection circuit 4a and the second current detection circuit 4b can respectively measure the current output by the first relay 22a and the second relay 22b, or respectively measure the current of the first charging gun 1a and the second charging gun 1b. The first current detection circuit 4a and the second current detection circuit 4b may include a current detector to implement the function of current detection. The first relay 22a and the second relay 22b can be categorized into electromagnetic relays, inductive relays, electronic relays, etc. according to their working principles. The switch control circuit can use different input signals to perform switch control based on different types of relay. In addition, the signal processing circuit 3 of the present embodiment can be connected to the first/second switch control circuit 23a/23b and other components of the first/second power supply circuit 2a/2b to control the switching of the charging current, and control various parameters of the charging current, such as power, current, time, frequency duty cycle, etc., through the first/second charging communication circuits 21a/21b.

The first current detection circuit 4a is configured to detect the first charging power and send the detection result back to the signal processing circuit 3, so that the signal processing circuit 3 adjusts the first charging power through the first charging communication circuit 21a. The second current detection circuit 4b is configured to detect the second charging power and send the detection result back to the signal processing circuit 3, so that the signal processing circuit 3 adjusts the second charging power through the second charging communication circuit 21b, wherein a sum of the first charging power and the second charging power is not greater than a maximum charging power. It should be noted that the first current detection circuit 4a and the second current detection circuit 4b in the present embodiment are optional.

In the present embodiment, the signal processing circuit 3 can perform the flowcharts shown in FIG. 3 and FIG. 4 to control the first power supply circuit 2a and the second power supply circuit 2b based on the trigger time point respectively. Or, the battery information of the electric vehicle can be included in the determination criteria. For example, for electric vehicles with high power, the output current of the corresponding power supply circuit can be reduced, and for electric vehicles with low power, the output current of the corresponding power supply circuit can be increased.

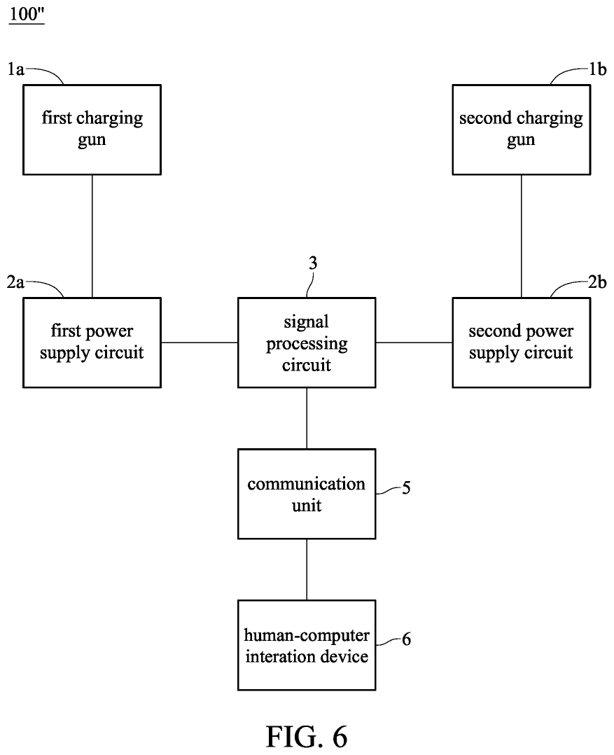

Please refer to FIG. 6 which is a functional block diagram of a dual-standard AC smart charging pile according to still another embodiment of the present disclosure. As shown in FIG. 6, in addition to the first charging gun 1a, the first power supply circuit 2a, the second charging gun 1b, the second power supply circuit 2b and the signal processing circuit 3, the dual-standard AC smart charging pile 100′ further includes a communication unit 5 and a human-computer interaction device 6. The communication unit 5 is connected to the signal processing circuit 3 in a wired or wireless way, and is configured to receive a user setting command. The signal processing circuit 3 is further configured to control one or both of the first charging power and/or the second charging power of the first charging gun 1a and the second charging gun 1b through the charging communication circuits in the first power supply circuit 2a and the second power supply circuit 2b according to the user setting command. The human-computer interaction device 6 is electrically connected to the communication unit 5, and the human-computer interaction device 6 has a graphical user interface for receiving the user setting command.

In the present embodiment, the communication unit 5 can be signally connected to the signal processing circuit 3 and the human-computer interaction device in a wireless or wired way. For example, the human-computer interaction device 6 can be a touch screen with a server for displaying a graphical user interface for the user to select user commands, and then transmit the user commands to the communication unit 5 for the signal processing circuit 3 to integrate information, to determine the charging scheme. Or, the human-computer interaction device 6 can be a user's mobile phone, and the communication unit 5 can be a remote server.

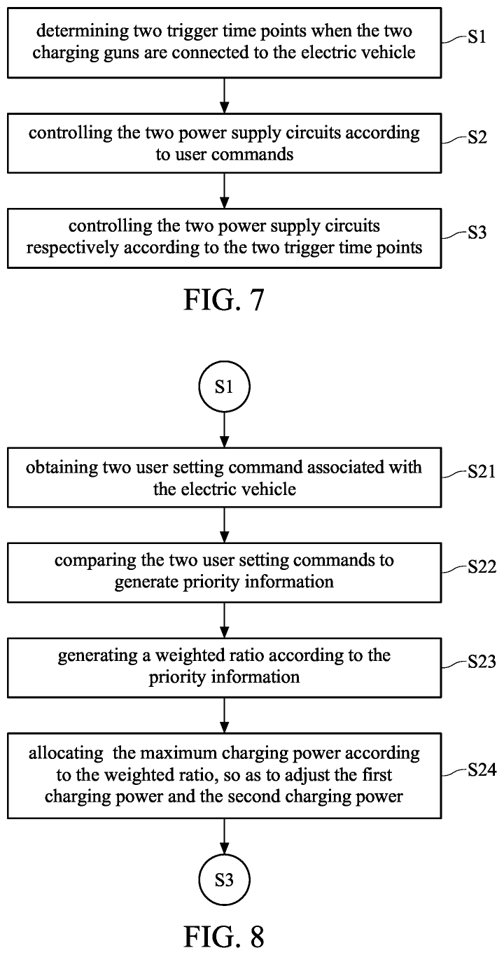

Please refer to FIG. 7 which is an operation flow chart of a dual-standard AC smart charging pile according to still another embodiment of the present disclosure. As shown in FIG. 7, in addition to performing the above-mentioned steps S1 and S3, the signal processing circuit of the present embodiment also performs step S2 therebetween: controlling the two power supply circuits according to user commands. In addition, the order of step S2 and step S3 can be swapped or can be performed at the same time, which is not limited in the present application.

In detail, please refer to FIG. 8 which is a detail operation flow chart of a dual-standard AC smart charging pile according to the embodiment shown in FIG. 7. As shown in FIG. 8, between step S1 and step S3, the signal processing circuit performs: step S21: obtaining two user setting commands associated with two electric vehicles; step S22: comparing the two user setting commands to generate priority information; step S23: generating a weighted ratio according to the priority information; and step S24: allocating the maximum charging power according to the weighted ratio, so as to adjust the first charging power and the second charging power.

Specifically, the signal processing circuit 3 of the present embodiment can obtain the first user setting command associated with the first electric vehicle and the second user setting command associated with the second electric vehicle through the communication unit shown in FIG. 6. Then the signal processing circuit 3 compares the two user setting commands to generate priority information, and generates a first weighted ratio corresponding to the first electric vehicle and a second weighted ratio corresponding to the second electric vehicle according to the priority information, to adjust the first charging power and the second charging power by allocating the maximum charging power, wherein a sum of the first charging power and the second charging power is not greater than the maximum charging power.

The various embodiments of the dual-standard AC smart charging pile described herein can be combined with each other. For example, the charging pile of the embodiment shown in FIG. 5 may include the communication unit and the human-computer interaction device of the embodiment shown in FIG. 6. The procedures for performing charging in various embodiments can also be combined with each other. For example, the control flow according to the trigger time point of the embodiment shown in FIG. 3 can be combined with the control flow according to the user setting command of the embodiment shown in FIG. 8, to meet requirements of the charging pile of the present application in various situations.

In view of the above description, the dual-standard AC smart charging pile of the present disclosure can be equipped with charging guns with different charging specifications, and can be used by different electric vehicles at the same time, and can implement smart current distribution according to the trigger time point of charging. In this way, by adopting a fixed current scheme, or depending on the power usage status in the field, or according to the management platform or the power supply setting results of individual piles, the power output can be regulated in a smart way. And it can be used for two parking spaces to share one charging pile, serving two vehicles of different specifications at the same time, and reducing the overall construction cost. In addition, the dual-standard AC smart charging pile disclosed in the present application can also perform algorithms based on user setting commands to meet requirements of application in various situations.

What is claimed is:

1. A dual-standard AC smart charging pile, comprising:
a first charging gun comprising a charging port conforming to a first specification;
a first power supply circuit electrically connected to the first charging gun and configured to provide power to the first charging gun based on the first specification;
a second charging gun comprising a charging port conforming to a second specification different from the first specification;
a second power supply circuit electrically connected to the second charging gun and configured to provide power to the second charging gun based on the second specification; and
a signal processing circuit electrically connected to the first power supply circuit and the second power supply circuit, and configured to control one or both of the first power supply circuit and the second power supply circuit according to one or both of a first trigger time point of the first charging gun and a second trigger time point of the second charging gun.

2. The dual-standard AC smart charging pile of claim 1, wherein the signal processing circuit is configured to:
when a time difference of the first trigger time point ahead of the second trigger time point is less than first threshold time, control a difference between first charging power outputted by the first power supply circuit and second charging power outputted by the second power supply circuit to be smaller than a preset error;
when the time difference is not less than the first threshold time and less than a second threshold time, control the second charging power to be higher than the first charging power by a first preset value; and
when the time difference is not less than the second threshold time, control the second charging power to be higher than the first charging power by a second preset value,
wherein the second threshold time is greater than the first threshold time, and the second preset value is greater than the first preset value.

3. The dual-standard AC smart charging pile of claim 1, wherein the signal processing circuit is configured to:
when a time difference of the first trigger time point ahead of the second trigger time point is less than first threshold time, control a difference between first charging power outputted by the first power supply circuit and a second charging power outputted by the second power supply circuit to be smaller than a preset error;
when a difference between the time difference and half of second threshold time is less than another preset error, control the second charging power to be higher than the first charging power by a third preset value; and
when the time difference is not less than the second threshold time, control the second charging power to be higher than the first charging power by a fourth preset value,
wherein half of the second threshold time is greater than the first threshold time, and the third preset value is greater than the fourth preset value.

4. The dual-standard AC smart charging pile of claim 1, wherein the first power supply circuit comprises:
a first charging communication circuit electrically connected to the first charging gun and the signal processing circuit, and the second power supply circuit comprises:
a second charging communication circuit electrically connected to the second charging gun and the signal processing circuit,
and the signal processing circuit is configured to:
when the first charging gun is connected to a first electric vehicle, obtain a first communication signal of the first electric vehicle through the first charging communication circuit to obtain the first trigger time point, and then control the first charging gun to output power through controlling the first power supply circuit according to the first specification and the first communication signal; and
when the second charging gun is connected to a second electric vehicle, obtain a second communication signal of the second electric vehicle through the second charging communication circuit to obtain the second trigger time point, and then control the second charging gun to output power through controlling the second power supply circuit according to the second specification and the second communication signal.

5. The dual-standard AC smart charging pile of claim 4, wherein the first power supply circuit further comprises:
a first relay electrically connected to the first charging gun, and configured to provide power to the first charging gun; and
a first switch control circuit electrically connected to the first relay and the signal processing circuit, and being controlled by the signal processing circuit to adjust the first relay to be in a disabled state or an enabled state;
and the second power supply circuit further comprises:
a second relay electrically connected to the second charging gun, and configured to provide power to the second charging gun; and
a second switch control circuit electrically connected to the second relay and the signal processing circuit, and being controlled by the signal processing circuit to adjust the second relay to be in a disabled state or an enabled state.

6. The dual-standard AC smart charging pile of claim 1, further comprising:
a first current detection circuit electrically connected to the first power supply circuit and the signal processing circuit, and configured to detect first charging power of the first power supply circuit and send a detection result of the first charging power back to the signal processing circuit, so that the signal processing circuit controls the first power supply circuit to adjust the first charging power; and
a second current detection circuit electrically connected to the second power supply circuit and the signal processing circuit, and configured to detect second charging power of the second power supply circuit and send a detection result of the second charging power back to the signal processing circuit, so that the signal processing circuit controls the second power supply circuit to adjust the first charging power,
wherein a sum of the first charging power and the second charging power is not greater than a maximum charging power.

7. The dual-standard AC smart charging pile of claim 1, further comprising:
a communication unit electrically connected to the signal processing circuit, and configured to receive a user setting command,
wherein the signal processing circuit is further configured to control one or both of the first charging power and/or the second charging power of the first power supply circuit and the second power supply circuit according to the user setting command.

8. The dual-standard AC smart charging pile of claim 7, wherein the signal processing circuit is configured to:
obtain a first user setting command associated with a first electric vehicle;
obtain a second user setting command associated with a second electric vehicle;
compare the first user setting command and the second user setting command to generate priority information;
generate a first weighted ratio and a second weighted ratio according to the priority information; and
allocate a maximum charging power according to the first weighted ratio and the second weighted ratio, so as to adjust the first charging power and the second charging power.

9. The dual-standard AC smart charging pile of claim 7, further comprising a human-computer interaction device electrically connected to the communication unit, wherein the human-computer interaction device has a graphical user interface for receiving the user setting command.

10. The dual-standard AC smart charging pile of claim 1, wherein the first specification is a charging specification according to one of SAE J1772 (Type 1), IEC 62196 (Type 2), GBT 20234.2-2015 and North American Charging Standard (NACS), and the second specification is a charging specification according to another one of SAE J1772 (Type 1), IEC 62196 (Type 2), GBT 20234.2-2015 and the NACS.
